(19) United States
(12) Patent Application Publication
(10) Pub. No.: US 2008/0023593 A1
(43) Pub. Date: Jan. 31, 2008

(54) AC/DC/DCC model train on board sound module with wireless control

(76) Inventors: Frank Ritota, Brick, NJ (US); Zhiping Lin, Kearney, NJ (US)

Correspondence Address: JONATHAN E. GRANT/GRANT PATENT SERVICES, 2107 HOUNDS RUN PLACE, SILVER SPRING, MD, 20906, US

(21) Appl. No.: 11/812,230

(22) Filed: Jun. 15, 2007

Related U.S. Application Data
(63) Continuation-in-part of application No. 11/030,959, filed on Jan. 10, 2005.

(51) Int. Cl. B61L 3/12; G05D 1/00

(52) U.S. Cl. 246/187 A; 701/19

(57) ABSTRACT

A method, apparatus and system for AC or DC track powered model trains which increases the number of remote control functions available to the powered engines via an on-board sound decoder module. The functions include sound functions, including bell, whistle, brakes, announcements, and the like, and any other functions programmed into the on-board sound decoder module. The invention is compatible with traditional AC, DC, and DCC systems and allows the hobbyist to use a wireless controller to operate the engines and associated functions in a remote fashion.

This application is a continuation in part of U.S. patent application Ser. No. 11/030,959, filed Jan. 10, 2005, hereby incorporated by reference.

### BACKGROUND OF THE DISCLOSURE

### Field of the Disclosure

This disclosure pertains to the field of control systems for model trains, and specifically to an improvement which provides an easy-to-use and affordable system which expands the number of “on board” features available, including, but not limited to, sounds, lights, and braking.

For many years, model railroaders have desired an affordable and easy-to-use life-like model train. Early Lionel AC model trains (driven by an AC motor) were powered by an AC power pack or power supply. The power pack fed AC power to the track and the model train picked up the power by its wheels and a center feed shoe to provide the AC power to the motor. The engine speed was controlled by the amplitude of the AC voltage on the track that was varied by the user operating the levers associated with the power pack. At a later time, Lionel introduced an innovative electrical-mechanical on-board motor control unit that allowed the hobbyist to change the engine's direction by simply interrupting the AC track power. This unit was later improved by adding a neutral state to allow the train to stand idle when the track voltage was applied. This feature allowed the engine's headlight or sound to stay on while the engine was stationary. Each time the AC power was interrupted, this motor control unit had a state sequence that moved from neutral to forward, forward to neutral, neutral to reverse, and reverse to neutral. This motor control unit is often referred to as a reverse unit or “E” unit, and consisted of a solenoid device. Later, Lionel added DC voltage to the AC track to trigger the on-board whistle. A further improvement was to use positive DC to activate the whistle and negative DC to turn on or off the train's bell.

Most early trains were powered by AC motors as a cheap, reliable DC motor was not yet available. With improvements in motor technology, small DC “can” motors were made available for use in the model train engines, having such improvements in slow speed and braking and greatly reduced “lugging” or stuttering when operating the engines at slow speed. With the addition of the DC “can” motors, the operative functions of the model trains were made to appear more realistic. Also, DC power packs were easier to manufacture for the increase power demands, with better power regulation. A DC power pack has a variable DC output controlled by a user-operated lever or the like, with a double-pole double-throw (DPDT) switch to change the polarity of the DC output. The DC model train's motor is directly connected to the pickup wheels and center shoe so the engine's speed is proportional to the DC track voltage. To change the engine's direction, the user simply flips the DPDT switch on the power pack to change the track's power polarity. Only one engine can be operated on the track insofar as the voltage is the same for the entire track, thus multiple engines on the same track cannot operate independently. Multiple blocks of track, each independently powered by individual power packs must be used to independently operate multiple engines with different directions and different speeds. This is referred to as “block switching” in the model train community, and has been a staple of multiple train operation during the “Golden Era”.

In recent years, a number of electronic control systems have been developed that attempt to solve the problems of independent train control and expand remote control capability. One approach is called digital command control, or DCC. It uses a command station attached to the model train track to send AC pulses in pulse width modulation (PWM) form onto the track where the train receives the pulses via the wheels and pickup shoe. A receiver or decoder is installed in the engine to decode the pulses and provide for the various operations that the pulses would be indicative of. The decoder includes a full wave bridge rectifier to convert the AC pulses to DC and decode the AC pulse width modulation (PWM) signals to provide the control signals that are used to determine the engine's speed and direction, as well as any additional commands, such as the various sounds and the like. The train tracks DC voltage level is kept at a constant value, with the DCC system throttling the power delivered to the engine via the decoder, the decoder also providing the needed voltage at the necessary level to operate any further accessories on the train, such as lights, sounds, etc. as desired or programmed.to provide the engine's necessary drive power, and then decodes the pulse width modulation (PWM) signals to provide the control signals that are used to determine the engine's speed and direction, as well as any additional commands, such as the various sounds and the like. Since the motor is no longer directly connected to the track, the changing polarity of the track will not change the engine's direction. The engine's speed and direction command, as well as any additional commands and control, can be encoded into the AC pwm pulse packet. By generating a stream of varying pulse widths (i.e., the AC PWM pulse), many states or signals can be encoded to control the engine and any associated model train functions. The current NMRA (National Model Railroaders Association) DCC protocol defines a 56 us (microsecond) AC pulse as a “1” and a 122 us pulse as a “0”. Thus, just as in any serial communication protocol, a combination of “1”s and “0”s can be used to form any digital command signal. The command station transmits a series of digital command packets onto the track which feeds the engine. A DCC packet contains a header, address field, data field, and error detection field. By assigning different addresses in the decoders associated with each individual model train engine, multiple engines can be controlled on a single track by addressing each engine individually, with the data field information providing the functions desired, such as setting the speed and direction, sounds, lights, braking, and the like.

DCC provides the most realistic model train operation was a great step forward for modern model railroading. However, the model train community is made up in large part by hobbyists from the “Golden Era” who still prefer to use conventional DC power packs to control their engines, avoiding the use of digital command control because they either find the digital command control system is too complicated or because they prefer to operate the model trains with vintage style power controllers that were a part of the equipment from their youth. Some digital command control systems can seem overwhelming to the traditional train hobbyist/operator, with a manual having many pages relating to various control schemes; therefore using a traditional DC power pack to control the on-board module is still the first choice of many hobbyists.

U.S. Pat. Nos. 4,914,431, 5,448,142, and 5,184,048 to Severson et al, introduce the concept of changing DC track polarity and timing the duration to generate signals in order to control an on-board unit. The on-board sound modules based on this concept use the DPDT switch on the power pack to generate a control signal. The engine's speed command is in proportion to the amplitude of the track voltage, with the engine's direction controlled by the initial track voltage polarity. A fast double change polarity is used to turn the engine's bell on or off. A single change of the polarity turns the whistle on, with another change back signal turns off the whistle. This on-board sound system can control the engine's direction, speed, and two extra remote functions, mainly whistle and bell, and is compatible with existing DC power packs.

The system disclosed by Severson et al. has the certain limitations. First, there is a significant delay in the blowing of the whistle. When the direction switch is toggled, the on-board sound unit has to wait for a period of time to make sure that it is not a double change of the DC track voltage polarity before it activates the whistle. Second, it is very hard to control the duration of the whistle. When the track polarity is changed to cease blowing the whistle, the sound unit has to wait for another period of time to make sure that it is not a double change of the track polarity. Third, the system only generates two states to control the on-board sound unit; thus there is no way to generate more than two states by the toggling of the DPDT switch. Fourth, the constant need to toggle the DPDT switch is bothersome. The user's fingers can become sore from the action of operating the switch. To make the unit more user-friendly, a push button and relay circuit has been introduced to replace the flipping of the DPDT switch; however, this adds to the cost of the unit.

U.S. Pat. Nos. 5,251,856, 5,441,223, and 5,749,547 issued to Young et al., disclose providing a digital message, which may include a command, to a model train using various techniques. The digital message(s) are typically read by a decoder mounted in the train, which then executes the decoded command. A remote control unit transmits radio frequency, infrared, or other signals to a base unit. The base unit combines a frequency shift key (FSK) signal with the power signal applied to the track to send an address and data signal to the powered block section of the track. The addressed train on that power block section will receive and decode the signal. The Young system does not send the signal directly to the on-board sound module.

### SUMMARY OF THE DISCLOSURE

To overcome the above limitations and reduce the cost, the present disclosure introduces a low cost, five function wireless transmitter and receiver chip set to generate control signals to the on-board sound module. Instead of using a DPDT switch to change the polarity of the track voltage to generate limited signals, the receiver chip sends 5-bit digital signals to the I/O port of the microcontroller of the on-board sound unit. The five-function wireless chip set can generate 5-bit binary code to input to the microcontroller on the on-board sound unit. This means that a low cost wireless solution can be used to activate up to 32 remote functions to control the on-board sound unit. That is enough to activate all the necessary on-board sounds and other functions and make model railroading more life-like.

In accordance with the present disclosure a control system has been developed for AC or DC powered model train system which uses an on-board sound module to control the model engine's sound and other on-board features. On-board means that it is integrated into a remote object (a minature model locomotive in this case) that is addressed by the remote control signals. The object is to increase the number of remote control functions to meet the ever increasing availability and desireability of “on-board” features, such as head light, tail light, Mars lights, whistle, air horn, bell, air release, brake, emergency stop, announcements, etc. This control system is compatible with traditional power packs, sending the control signals wirelessly rather than through the power on the track. Using the wireless controller, the hobbyist will also be able to walk around his layout to operate his engines unencumbered.

### DESCRIPTION OF THE FIGURES

FIG. 1 is a perspective view of the system:

FIG. 2 is a general schematic of the system:

FIG. 3 is a schematic of the system with a model train under DCC control:

FIG. 4 is a schematic of the system with an AC powered model train driven by a DC motor;

FIG. 5 is a schematic of the system associated with a DC powered model train; and

FIG. 6 is a perspective view of the wireless remote control device.

### DETAILED DESCRIPTION OF THE DISCLOSURE

The control system can be implemented for DC model trains and some AC model trains driven by DC motors. FIG. 1 is a pictorial view of the wireless system.

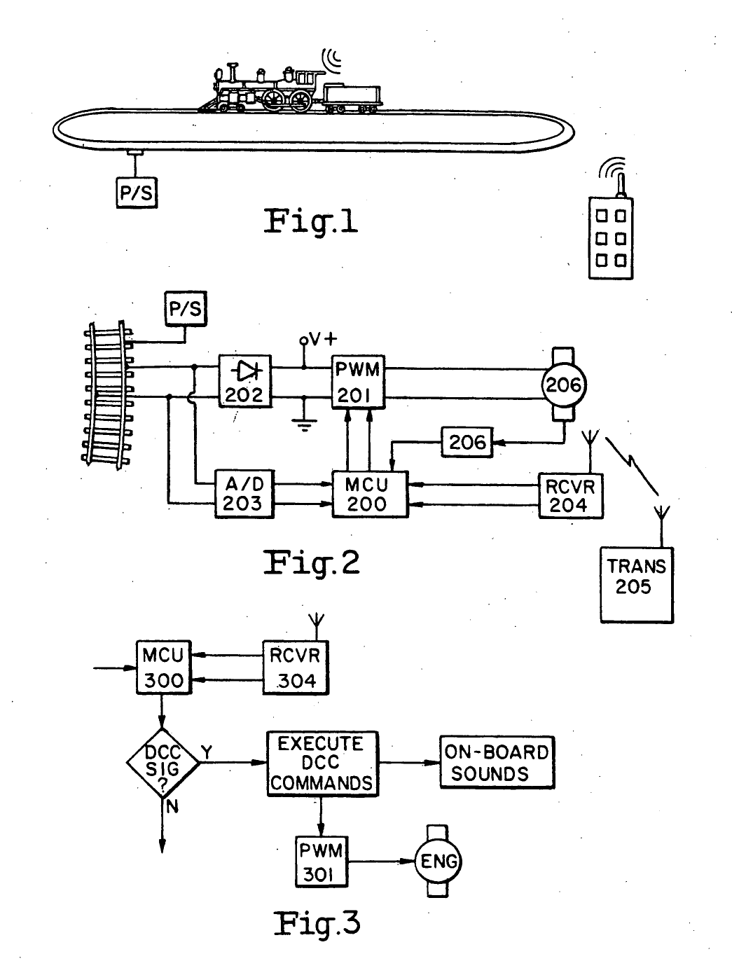

FIG. 2 is a schematic of the most general case. Block 205 represents the wireless transmitter. Block 204 represents the function receiver. Block 202 is a full bridge rectifier with filter. The rectifier converts the track power to DC to power the PWM circuit and microcontroller (MCU), as well as provide power to the model train's motor. Block 203 is a two-channel analog-to-digital converter, A/D. Block 200 is a MCU. The MCU is used to measure the voltage of both rails of the track and their waveform. By monitoring both rails of the track waveform, the MCU can identify the type of track power. Block 201 represents the PWM. The DC motor which drives-the engine is represented by 206.

As shown in FIG.3, if the MCU 300 detects a DCC track signal, it starts the DCC operation. The on-board sound module will act as a regular DCC sound decoder. The MCU 300 will receive the DCC command control packet to decode the command and control the engine's speed and direction by PWM block 301. It will also receive accessory commands to control on-board sounds accordingly. Since some DCC systems on the market do not have enough accessory functions to control the on-board sound, the MCU 300 will also activate the wireless function to control those additional functions and sounds not covered by the DCC system, effectively all of the sounds and functions that are stored in the flash memory chip in digital form.

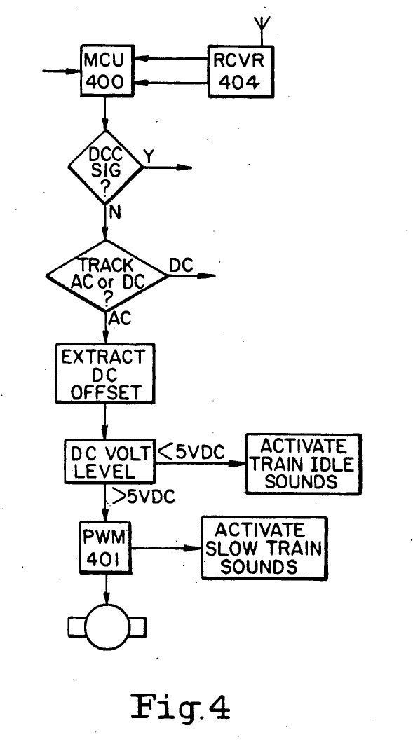

If the MCU does not detect a DCC track signal, it will try to determine whether the track is AC powered or DC powered. If it finds the power track is AC, as shown in FIG. 4, the MCU 400 will automatically compensate the DC offset to get the correct speed command while the user presses the Bell or Horn button on the AC pack 407. During AC operation the control unit will automatically set from neutral to forward, forward to neutral, neutral to reverse, and reverse to neutral sequentially when it detects an interruption of track power. The amplitude of the AC voltage on the track controls the speed of the AC model train. When the AC track voltage is less than 5 VAC, the MCU 400 will not output the PWM 401 to the DC motor; therefore the engine will not move, but instead will sit idle with the engine idle sound operating. When the AC track voltage is greater than 5 VAC, the MCU 400 will output the PWM 401 to the DC motor and generate the engine sounds associated with the slow movement, the engine starting to move and make the sounds associated with a slowly moving train. When the user presses the whistle or other sound key on the wireless transmitter 406, the transmitter will transmit a 5-bit binary code to the wireless function receiver. The receiver will pass the code to the MCU and the MCU will activate the whistle or other sounds. The hobbyist can thus use the AC power pack to control the model train speed and direction in the traditional ways and use the wireless transmitter to activate the on-board sounds and functions.

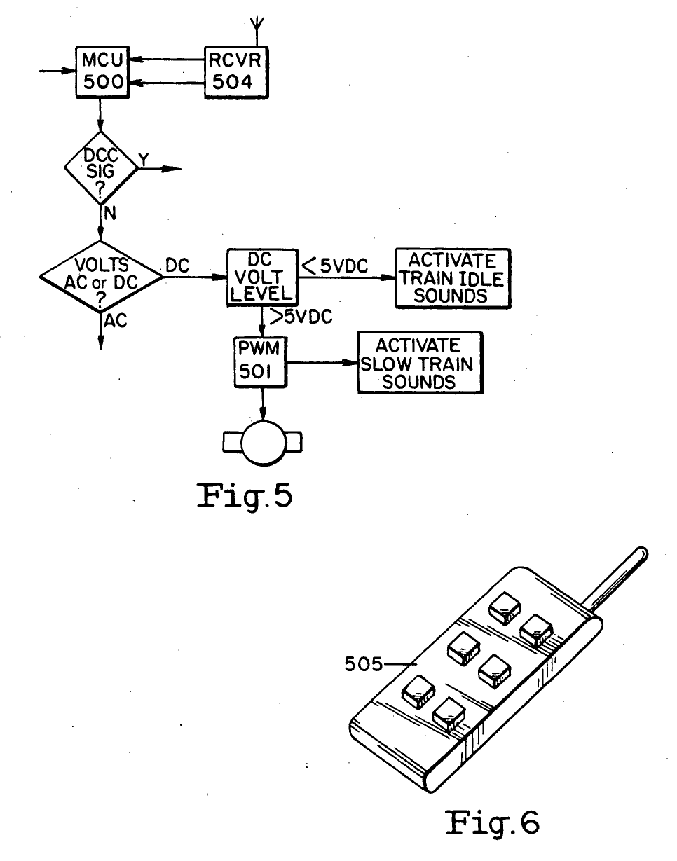

If the MCU does not detect a DCC track signal or AC voltage on the powered track, it determines that the track is powered by a DC power pack 507. FIG. 5 shows a schematic of this case. When the DC track voltage is less than 5V, the MCU 500 will not output the PWM 501 to the DC motor; consequently the engine will not move. It will sit idle with the idle engine sound. When the track voltage is greater than 5 V, the MCU 500 will output the PWM 501 to the DC motor and generate the engine sounds associated with the engine starting to move and the slow moving sound generated. By detecting the polarity of the track MCU 500 controls the PWM 501 and accordingly controls the engine's direction. When the user presses the whistle or other sound key on the wireless transmitter 505, the transmitter will transmit a 5-bit binary code to the receiver 504. The wireless function receiver 504 will pass the code to the MCU 500 and the MCU will activate the whistle or other sounds. The hobbyist can thus use the DC power pack 507 to control the model train speed and direction in the traditional ways and uses the wireless transmitter to activate the on-board sounds and functions.

A program executed on a computer and associated with the on-board sound module causes the computer to perform the steps of receiving and decoding the digital control signal to control the on-board train functions, such as various sounds and lighting functions.

A further embodiment of the DCC control for the MCU would include the use of direct wireless reception of the wireless control signals to the MCU via a UART (universal asynchronous receiving transmitter) incorporated in the MCU. The UART receives the transmitted commands directly from the wireless transmitter without having to pass the signals to the wireless function receiver, allowing the track to be powered by a standard DC or AC power pack.

The thus modified MCU would be placed in the model train engine or, if desired, various model cars, to provide the needed functionality.

The UART may be included as a separate chip in an electrical connection to the MCU and mounted on the same board, it it may be manufactured on the same silicone chip as the MCU.

The wireless transmitter would incorporate an RF module that is used to transmit the commands wirelessly directly to the UART incorporated MCU for execution in the model train.

While presently preferred embodiments have been described above, various other modifications and adaptations of the instant invention can be made by those persons skilled in the art without departing from either the spirit of the invention or the scope of the appended claims.

We claim:

1. An apparatus for providing a new control capability for DC model trains and for AC model trains driven by DC motors, said apparatus comprising:
a) a wireless transmitter;
b) a wireless function receiver;
c) full bridge rectifier;
d) pulse width modulator (PWM);
e) two-channel analog-to-digital converter (A/D); and
f) a micro-controller unit (MCU).

2. The apparatus in accordance with claim 1, wherein said wireless transmitter comprises:
a) a wireless signal generation device which generates a binary code,
b) an antenna,
c) and user selection means.

3. The wireless signal generation device which generates a binary code in accordance with claim 2, wherein said wireless signal generation device is a five-function chip and wherein said binary code is a 5-bit binary code.

4. The apparatus in accordance with claim 2, wherein said user selection means are pushbuttons.

5. The apparatus in accordance with claim 1, wherein the micro-controller unit (MCU) is located inside the model trains.

6. The apparatus in accordance with claim 1, wherein said model trains are DCC controlled.

7. The apparatus in accordance with claim 1, wherein said model trains are AC powered model trains driven by DC motors.

8. The apparatus in accordance with claim 1, wherein said model trains are DC powered model trains.

9. The apparatus in accordance with claim 1, wherein said MCU provides automatic detection means wherein said means is selected from the group consisting of:
model trains under DCC control, AC powered model trains driven by a DC motor,
and DC powered model trains.

10. The apparatus in accordance with claim 1 wherein said MCU provides automatic detection means wherein said means is selected from a group consisting of:
model trains under DCC control, AC powered model trains driven by a DC motor, or DC powered trains.

12. The apparatus in accordance with claim 1, wherein said MCU includes a universal asynchronous receiver transmitter.

13. The apparatus in accordance with claim 1, wherein said wireless transmitter includes an RF module to directly transmit commands to the universal asynchronous receiver transmitter.

14. A method for providing a new control capability for DC model trains and for AC model trains driven by DC motors; said method comprising the steps of:
a) transmitting wirelessly a digital control function wherein a transmitter transmits to a wireless function receiver;
b) receiving a control signal via said wireless function receiver;
c) feeding digital signals directly to the I/O port of the microcontroller of the on-board sound unit;
d) detecting and controlling said model trains using a micro-controller unit (MCU), wherein said digital control function provides an on-board function.

15. The method in accordance with claim 14, wherein said model trains are DCC controlled.

16. The method defined by claim 14, wherein said model trains are AC powered model trains driven by DC motors.

17. The method in accordance with claim 14, wherein said model trains are DC powered model trains.

18. The method in accordance with claim 14, wherein said MCU provides automatic detection means wherein said means is selected from the group consisting of:
model trains under DCC control, AC powered model trains driven by a DC motor, and DC powered model trains.

19. The method in accordance with claim 14, wherein said MCU provides automatic detection means wherein said means is selected from the group consisting of:
model trains under DCC control, AC powered model trains driven by a DC motor, and DC powered model trains.

20. The method in accordance with claim 14, wherein the transmitter transmits a digital control function in a wireless fashion directly to a universal asynchnronous receiver transmitter located on the MCU via an RF module located on the transmitter.

21. A system for providing a new control capability for DC model trains and for AC model trains driven by DC motors, said system comprising:
a) a wireless transmitter;
b) a two-channel analog-to-digital converter (A/D);
c) a micro-controller unit (MCU);
d) a pulse width modulator (PWM);
e) a wireless function receiver; and
f) a full bridge rectifier with filter which converts track power to DC to power the PWM circuit and microcontroller (MCU).

22. The system in accordance with claim 21, wherein said model trains are DCC controlled.

23. The system in accordance with claim 21, wherein said model trains are AC powered model trains driven by DC motors.

24. The system in accordance with claim 21, wherein said model trains are DC powered model trains.

25. The system in accordance with claim 21, wherein said MCU provides automatic detection means wherein said means is selected from the group consisting of:
model trains under DCC control, AC powered model trains driven by a DC motor, and DC powered model trains.

26. The system in accordance with claim 21, wherein said MCU provides automatic detection means wherein said means is selected from the group consisting of:
model trains under DCC control, AC powered model trains driven by a DC motor, and DC powered model trains.

27. A program when executed on a computer associated with the on-board sound module on model trains causes the computer to perform the steps of:
a) receiving a digital control signal;
b) decoding said digital control signal; and
c) using said digital control signal, controlling on-board train functions;

28. The program in accordance with claim 27, wherein said model trains are DCC controlled.

29. The program in accordance with claim 27, wherein said model trains are DC powered model trains.

30. The program in accordance with claim 27, wherein said model trains are AC powered model trains driven by DC motors.

31. The program in accordance with claim 27, wherein said program provides automatic detection means wherein said means is selected from the group consisting of:
model trains under DCC control, AC powered model trains driven by a DC motor, and DC powered model trains.

32. The program in accordance with claim 27, wherein said program provides automatic detection means wherein said means is selected from the group consisting of:
model trains under DCC control, AC powered model trains driven by a DC motor, and DC powered model trains.
